(19) United States
(12) Patent Application Publication
(10) Pub. No.: US 2026/0219618 A1
(43) Pub. Date: Jul. 30, 2026

(54) FIXING MEMBER, FIXING DEVICE, IMAGE FORMING APPARATUS, AND METHOD OF FORMING RELEASE LAYER OF FIXING MEMBER

(71) Applicant: FUJIFILM Business Innovation Corp., Tokyo (JP)

(72) Inventors: Ryohei YOSHIKAWA, Kanagawa (JP); Taiki NAGAMATSU, Kanagawa (JP); Tomotake INAGAKI, Kanagawa (JP); Hitoshi KOMURO, Kanagawa (JP); Yasuhiko KINUTA, Kanagawa (JP); Jun KIMURA, Kanagawa (JP); Masayuki SEKO, Kanagawa (JP); Kenji KAJIWARA, Kanagawa (JP)

(73) Assignee: FUJIFILM Business Innovation Corp., Tokyo (JP)

(21) Appl. No.: 19/428,374

(22) Filed: Dec. 22, 2025

(30) Foreign Application Priority Data
Jan. 24, 2025 (JP) 2025-010967
Oct. 8, 2025 (JP) 2025-170437

(51) Int. Cl. G03G 15/20

(52) U.S. Cl. CPC G03G 15/2057; G03G 15/206; G03G 15/2064; G03G 2215/2051; G03G 2215/2054

(57) ABSTRACT

A fixing member includes a base material, and a release layer that is provided on the base material and contains a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group) and inorganic particles having an average particle diameter of 0.5 μm or more and 15 μm or less.

### CROSS-REFERENCE TO RELATED APPLICATIONS

This application is based on and claims priority under 35 USC 119 from Japanese Patent Application No. 2025-170437 filed Oct. 8, 2025 and Japanese Patent Application No. 2025-010967 filed Jan. 24, 2025.

### BACKGROUND

### (i) Technical Field

The present invention relates to a fixing member, a fixing device, an image forming apparatus, and a method of forming a release layer of a fixing member.

### (ii) Description of Related Art

In an image forming apparatus (such as a copy machine, a facsimile machine, and a printer) using an electrophotographic method, a toner image formed on a surface of an image holder is transferred to the surface of a recording medium and fixed on the recording medium such that an image is formed.

For example, JP2004-086202A discloses “fixing element for electrophotography, containing a fluororesin consisting of a copolymer (PFA) of tetrafluoroethylene and perfluoroalkyl vinyl ether, that is compounded with inorganic filler particles, in at least a surface layer provided on an outer peripheral surface”.

JP2011-008109A discloses “rotating body for a fixing device, including a base material and a surface layer provided on an outer peripheral surface of the base material, the surface layer containing a tetrafluoroethylene-perfluoroalkyl vinyl ether copolymer and inorganic particles having a value of a shape factor SF1 and a value of a shape factor SF2 satisfying specific conditions”.

JP2012-173739A discloses “pressurizing member including a base material and an outermost layer that contains carbon nanotubes and an elastic material dispersed in a fluororesin material, in which the elastic material is at least partially crosslinked”.

### SUMMARY

Aspects of non-limiting embodiments of the present disclosure relate to a fixing member including a release layer that contains a polysiloxane compound having a T unit represented by a formula: [R¹SiO_{3/2}]ₘ and inorganic particles, in which the fixing member has excellent release properties and abrasion resistance as compared to a case in which an average particle diameter of the inorganic particles is less than 0.5 μm or more than 15 μm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above object include the following aspects.

According to an aspect of the present disclosure, there is provided a fixing member including:
a base material; and
a release layer that is provided on the base material and contains a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group) and inorganic particles having an average particle diameter of 0.5 μm or more and 15 μm or less.

### BRIEF DESCRIPTION OF THE DRAWINGS

Exemplary embodiment(s) of the present invention will be described in detail based on the following figures, wherein:

FIG. 1 is a view schematically showing a configuration of an example of a first exemplary embodiment of a fixing device according to the present exemplary embodiment;

FIG. 2 is a view schematically showing a configuration of an example of a second exemplary embodiment of a fixing device according to the present exemplary embodiment; and

FIG. 3 is a view schematically showing a configuration of an example of an image forming apparatus according to the present exemplary embodiment.

### DETAILED DESCRIPTION

Hereinafter, present exemplary embodiments of the present invention will be described. The following descriptions and examples merely illustrate the exemplary embodiments, and do not limit the scope of the exemplary embodiments.

Regarding the numerical ranges described in stages in the present exemplary embodiment, the upper limit value or lower limit value of a numerical range may be replaced with the upper limit value or lower limit value of another numerical range described in stages. In addition, in the present exemplary embodiment, the upper limit value or lower limit value of a numerical range may be replaced with values described in examples.

In the present exemplary embodiments, the term “step” includes not only an independent step but a step which is not clearly distinguished from other steps as long as the intended purpose of the step is achieved.

In the present exemplary embodiment, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present exemplary embodiments, each component may include a plurality of corresponding substances. In the present exemplary embodiment, in a case where the amount of each component in a composition is mentioned, and there are two or more kinds of substances corresponding to each component in the composition, unless otherwise specified, the amount of each component means the total amount of two or more kinds of the substances present in the composition.

### Fixing Member

The fixing device according to the present exemplary embodiment includes a base material and a release layer provided on the base material.

The release layer contains a polysiloxane compound having a T unit represented by a formula: [R¹SiO_{3/2}]ₘ (hereinafter, also referred to as “polysiloxane compound SQ”) and inorganic particles having an average particle diameter of 0.5 μm or more and 15 μm or less.

In the formula of the unit T, R¹ represents an organic group, m represents an integer of 2 or more, and at least one R¹ among a plurality of R¹'s present in the T unit is a group including at least one of an alkyl group or an aryl group.

In recent years, due to increased awareness of sustainable development goals (SDGs), the developments of materials with reduced environmental burden have been promoted. One of techniques is to use a polysiloxane compound.

Here, the release layer containing the polysiloxane compound SQ has excellent release properties. However, the abrasion resistance is low.

Therefore, in the fixing member according to the present exemplary embodiment, the release layer contains the inorganic particles having an average particle diameter in the above-described range together with the polysiloxane compound SQ. As a result, a hardness of the release layer is improved, and it is difficult for the release properties of the release layer to be reduced due to the inclusion of the inorganic particles.

Therefore, the fixing member according to the present exemplary embodiment is a fixing member having excellent release properties and abrasion resistance.

Hereinafter, details of the fixing member according to the present exemplary embodiment will be described.

The fixing member according to the present exemplary embodiment includes a base material and a release layer. A functional layer such as an elastic layer may be provided between the base material and the release layer.

The fixing member according to the present exemplary embodiment may have a roll shape or a belt shape.

### Base Material

Examples of the base material include a cylindrical base material formed of a metal (aluminum, SUS, iron, copper, or the like), an alloy, ceramics, a fiber-reinforced metal (FRM), or the like.

An outer diameter and a thickness of the cylindrical base material may be, for example, an outer diameter of 10 mm or more and 50 mm or less. In a case of the aluminum cylindrical base material, the thickness may be, for example, 0.5 mm or more and 4 mm or less; and in a case of the SUS (stainless steel) cylindrical base material or the iron cylindrical base material, the thickness may be, for example, 0.1 mm or more and 2 mm or less.

Examples of the base material also include a metal belt and a heat-resistant resin belt.

Examples of the metal belt include a metal belt formed of nickel, aluminum, stainless steel, or the like.

Examples of the heat-resistant resin belt include a heat-resistant resin belt formed of polyimide, polyamideimide, polyphenylene sulfide, polyether ether ketone, polybenzimidazole, or the like.

The heat-resistant resin belt may contain a conductive powder or the like in order to control a volume resistivity. Specifically, examples of the resin belt include a polyimide resin belt in which carbon black is added and dispersed. In addition, examples of the heat-resistant resin belt also include a belt formed by combining both ends of a long polyimide sheet in a puzzle shape and performing thermocompression using a thermocompression member to obtain a belt-shaped product.

Furthermore, the term “heat-resistant” means a characteristic that melting or decomposition does not occur in a case of reaching a raised temperature of the fixing device (for example, a fixing temperature).

A thickness of the belt base material is, for example, preferably 20 μm or more and 200 μm or less, more preferably 30 μm or more and 150 μm or less, and still more preferably 40 μm or more and 130 μm or less.

A metal layer may be provided on the base material as necessary. In a case where the metal layer is provided, the metal layer may be formed in a single layer or may be formed in multiple layers. The metal layer formed in a single layer may be an electromagnetic induction metal layer that generates heat by electromagnetic induction. In addition, the metal layer formed in multiple layers may be formed in a three-layer structure of, for example, an underlayer metal layer, an electromagnetic induction metal layer, and a metal protective layer.

An adhesive may be applied onto a surface of the base material. That is, the adhesive is used as necessary, and the base material (or the metal layer on the base material) and the elastic layer or the release layer may be laminated with the adhesive interposed therebetween. The adhesive is not particularly limited, and examples thereof include an adhesive compound having a hydrogen-bonding silyl group (—SiH) in which a hydrogen atom is bonded.

### Release Layer

The release layer contains the polysiloxane compound SQ and inorganic particles.

The release layer may be a release layer containing the polysiloxane compound SQ as a principal component (for example, a matrix material that is to be a binding material), or a release layer containing the polysiloxane compound as an additive. The release layer may contain other additives.

Here, the release layer containing the polysiloxane compound SQ as a principal component (for example, a matrix material that is to be a binding material) refers to a release layer having the highest amount of the polysiloxane compound.

### Polysiloxane Compound SQ

The polysiloxane compound SQ is a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group).

The polysiloxane compound SQ may be a polysiloxane compound having a D unit represented by a formula: (R²R³SiO_{2/2})ₙ (in the formula, R² and R³ are organic groups, and n is an integer of 2 or more), together with the T unit represented by the formula: [R¹SiO_{3/2}]ₘ.

For example, it is preferable that at least one of R² or R³ among a plurality of R²'s and R³'s present in the D unit is a group including at least one of an alkyl group or an aryl group.

In the T unit and the D unit, the organic group of R¹, R², and R³ in the formulae represents, for example, a hydroxyl group, a siloxy group, a hydrocarbon group, a hydrocarbon group in which one or a plurality of methylene groups are replaced with a carbonyl group, a hydrocarbon group in which one or a plurality of carbon atoms are replaced with a heteroatom (an oxygen atom, a nitrogen atom, or a sulfur atom), or a group obtained by combining these groups.

Examples of the siloxy group described as the organic group represented by R¹, R², and R³ include a monoalkylsiloxy group, a dialkylsiloxy group, and a trialkylsiloxy group; and for example, a dialkylsiloxy group or a trialkylsiloxy group is preferable, and a trialkylsiloxy group is more preferable.

Examples of the hydrocarbon group described as the organic group represented by R¹, R², and R³ include an aliphatic hydrocarbon group and an aromatic hydrocarbon group.

Examples of the aliphatic hydrocarbon group include a linear, branched, or alicyclic saturated aliphatic hydrocarbon group, and a linear, branched, or alicyclic unsaturated aliphatic hydrocarbon group.

The aliphatic hydrocarbon group is, for example, preferably a hydrocarbon group having 1 or more and 20 or less carbon atoms, and more preferably a hydrocarbon group having 1 or more and 15 or less carbon atoms.

The aliphatic hydrocarbon group may be substituted with a substituent such as a halogen atom, a hydroxyl group, an amino group, and an aryl group.

Examples of the aromatic hydrocarbon group include a hydrocarbon group having 6 or more and 18 or less carbon atoms (for example, preferably 6 or more and 14 or less carbon atoms). Examples of the aromatic hydrocarbon group include a phenyl group, a naphthyl group, and an anthracenyl group.

The aromatic hydrocarbon group may be substituted with a substituent such as a halogen atom, a hydroxyl group, an amino group, an alkyl group, and an alkoxy group.

The organic group represented by R¹, R², and R³ may have a reactive group. Examples of the reactive group include a vinyl group, an allyl group, a styryl group, a maleimide group, an epoxy group, and a (meth)acryloyl group. That is, the siloxane compound may be a cured product in which the above-described reactive group is reacted.

A plurality of R¹'s, R²'s, and R³'s present in the T unit and the D unit may be the same organic group or different organic groups.

However, at least one R¹ among the plurality of R¹'s present in the T unit is a group including at least one of an alkyl group or an aryl group.

In addition, at least one R² or R³ among the plurality of R²'s and R³'s present in the D unit is, for example, preferably a group including at least one of an alkyl group or an aryl group.

That is, at least one R¹ among the plurality of R¹'s present in the T unit is a group including at least one of an alkyl group or an aryl group.

For example, it is preferable that at least one R² among the plurality of R²'s present in the D unit is a group including at least one of an alkyl group or an aryl group.

For example, it is preferable that at least one R³ among the plurality of R³'s present in the D unit is a group including at least one of an alkyl group or an aryl group.

Here, from the viewpoint of improving the release properties, as the group including an alkyl group, for example, an alkyl group itself or a siloxy group including an alkyl group is preferable. That is, at least one of the plurality of R¹, R², or R³ present in the T unit and the D unit is, for example, preferably an alkyl group or a siloxy group including an alkyl group.

From the viewpoint of improving the release properties, the alkyl group is, for example, preferably an alkyl group having 1 or more and 6 or less carbon atoms, and more preferably an alkyl group having 1 or more and 4 or less carbon atoms or an alkyl group having 1 carbon atom (that is, a methyl group).

As the group including an aryl group, for example, an aryl group itself or an aralkyl group is preferable.

Examples of the aryl group include a phenyl group and a naphthyl group.

Examples of an alkyl group in the aralkyl group include a linear or branched alkyl group having 1 or more and 4 or less carbon atoms. Examples of an aryl group in the aralkyl group include a phenyl group and a naphthyl group. Examples of the aralkyl group include a benzyl group, a 1-phenylethyl group, a 2-phenylethyl group, and a 2-methyl-2-phenylethyl group.

From the viewpoint of improving the release properties, as the group including an aryl group, for example, a phenyl group is preferable.

From the viewpoint of improving the release properties, for example, it is preferable that a presence proportion of the group including at least one of an alkyl group or an aryl group is high with respect to the polysiloxane compound SQ.

In the T unit and the D unit, m and n in the formulae represent an integer of 2 or more; and from the viewpoint of improving the release properties, for example, an integer of 8 or more is preferable, and an integer of 8 or more and 10,000 or less is more preferable.

In the T unit and the D unit, the upper limit of a ratio m/n of m and n in the formulae is, for example, preferably 100/0 or less, and more preferably 100/1 or less. In addition, the lower limit of m/n is, for example, preferably 10/90 or more, more preferably 20/80 or more, and still more preferably 25/75 or more.

The ratio m/n, that is, the ratio of the T unit and the D unit is measured as follows. The ratio m/n is calculated based on the peak ratio of the D unit (high ppm side) and the T unit (low ppm side) by solid ²⁹Si NMR.

From the viewpoint of improving the release properties, a content of the polysiloxane compound SQ with respect to the release layer is, for example, preferably 10% by volume or more, more preferably 30% by volume or more, and still more preferably 50% by volume or more.

The polysiloxane compound SQ may be in a particle shape. A volume average particle diameter of the particle-shaped polysiloxane compound SQ is, for example, preferably 0.01 μm or more and 10 μm or less, more preferably 0.01 μm or more and 5 μm or less, and still more preferably 0.01 μm or more and 2.5 μm or less. The volume average particle diameter of the particle-shaped polysiloxane compound SQ is, for example, particularly preferably 2.5 μm or less and more preferably 1 μm or less.

In a case where the volume average particle diameter of the particle-shaped polysiloxane compound SQ is within the above-described range, the release properties are likely to be improved.

The volume average particle diameter of the particle-shaped polysiloxane compound SQ is measured as follows.

A sample is collected from the release layer. The sample is a sample in which a cut surface along a thickness direction of the release layer is used as an observation surface.

The observation surface of the sample is observed with a scanning electron microscope to capture an image. In the image, an area of each primary particle of the polysiloxane compound SQ is measured by image analysis, and an equivalent circle diameter thereof is calculated from this area value. The calculation of the equivalent circle diameter is carried out for 100 particles of the polysiloxane compound SQ. A 50% diameter (D50v) in the volume-based cumulative frequency of the obtained equivalent circle diameter is defined as the volume average particle diameter of the polysiloxane compound SQ.

Examples of the polysiloxane compound SQ include a polymer compound referred to as silsesquioxane (SQ) having various skeleton structures.

The polysiloxane compound SQ may have, as a skeleton structure, any of a cage-type structure (a perfect cage-type structure or a cage-type structure), a ladder-type structure, or a random structure.

### Inorganic Particles

As the inorganic particles, inorganic particles having an average particle diameter of 0.5 μm or more and 15 μm or less are applied.

In a case where the average particle diameter of the inorganic particles is less than 0.5 μm, the abrasion resistance is reduced.

In a case where the average particle diameter of the inorganic particles is more than 15 μm, the release properties are reduced.

From the viewpoint of improving the release properties and the abrasion resistance, the average particle diameter of the inorganic particles is, for example, preferably 1 μm or more and 10 μm or less.

A method of measuring the average particle diameter of the inorganic particles is as follows.

A test piece having an area of 1 mm² is cut out from the fixing member, and the test piece is embedded in an epoxy resin. Cross-sectional processing is performed on the embedded product with a microtome to form a block cross-section in which a cross-section taken in a thickness direction of the release agent is visible. The sample in which the block cross-section is formed is imaged with a scanning electron microscope (SEM). The SEM observation is performed at a magnification ratio in which fillers dispersed in the molded body can be observed. The obtained SEM image is read into an image processing and analysis device to perform image analysis. 100 primary particles of the inorganic particles in the release layer are randomly selected, an equivalent circle diameter (μm) of each of the primary particles is obtained, and the equivalent circle diameters are arithmetically averaged. The arithmetic average value is defined as the average particle diameter of the inorganic particles.

Examples of the inorganic particles include particles of a metal, a metal sulfate, a metal sulfide, a metal oxide, an inorganic nitride, a carbon material, a mineral, or the like.

Examples of the metal include aluminum, iron, copper, nickel, gold, silver, platinum, cobalt, zinc, lead, tin, titanium, chromium, magnesium, manganese, and an alloy of two or more of these metals.

Examples of the metal sulfate include barium sulfate, aluminum sulfate, calcium sulfate, magnesium oxide, aluminum borate, and potassium titanate.

Examples of the metal sulfide include molybdenum disulfide, tungsten disulfide, and zinc sulfide.

Examples of the metal oxide include silica, titania, alumina, tin oxide, magnesium oxide, and iron oxide.

Examples of the inorganic nitride include boron nitride, aluminum nitride, silicon nitride, and titanium nitride.

Examples of the carbon material include carbon black, carbon nanotubes, carbon nanofibers, carbon fibers, graphite (natural graphite, artificial graphite, and the like), and fullerene.

Examples of the mineral include mica, talc, and smectite (hectorite, saponite, stevensite, beidellite, or montmorillonite).

Among these, the inorganic particles are, for example, more preferably at least one kind of particles selected from the group consisting of molybdenum disulfide, mica, and barium sulfate, and still more preferably particles of molybdenum disulfide. In a case where particles of a lamellar compound having cleavability, such as the particles of molybdenum disulfide, are applied, lubricity of the surface of the release layer is improved. As a result, the abrasion resistance is likely to be improved.

A content of the inorganic particles with respect to the release layer is, for example, preferably 0.9% by mass or more and 11% by mass or less, and more preferably 3% by mass or more and 7% by mass or less.

In a case where the content of the inorganic particles is 0.9% by mass or more, the abrasion resistance is likely to be improved.

In a case where the content of the inorganic particles is 11% by mass or less, the reduction in release properties is likely to be suppressed.

### Binding Material

The release layer may contain a binding material for immobilizing the polysiloxane compound SQ and the inorganic particles.

Examples of the binding material include a heat-resistant release material.

Examples of the heat-resistant release material include a fluororubber, a fluororesin, a silicone resin, a silicone rubber, a polyimide resin, a polyether ether ketone (PEEK) resin, a polyphenylene sulfide (PPS) resin, and a polymethylpentene (PMP) resin.

Among these, as the heat-resistant release material, for example, a silicone resin or a silicone rubber is preferable.

Furthermore, the term “heat-resistant” means a characteristic that melting or decomposition does not occur in a case of reaching a raised temperature of the fixing device (for example, a fixing temperature).

Examples of the silicone resin include a methyl-based straight silicone resin, a methylphenyl-based straight silicone resin, an acrylic resin-modified silicone resin, an ester resin-modified silicone resin, an epoxy resin-modified silicone resin, and an alkyd resin-modified silicone resin.

Examples of the silicone rubber include room temperature vulcanizing (RTV) silicone rubber, high temperature vulcanizing (HTV) silicone rubber, and liquid silicone rubber, and specific examples thereof include polydimethyl silicone rubber, methylvinyl silicone rubber, methylphenyl silicone rubber, and fluorosilicone rubber.

### Other Additives

The release layer may be compounded with other additives. Examples of the additive include a softener (paraffin-based softener and the like), a processing aid (stearic acid and the like), and an aging inhibitor (amine-based aging inhibitor and the like).

### Characteristics of Fixing Member

### Coefficient of Dynamic Friction

In the fixing member according to the present exemplary embodiment, a coefficient of dynamic friction on the surface of the release layer with respect to a recording medium is, for example, preferably 0.20 or more and 0.40 or less, and more preferably 0.22 or more and 0.34 or less.

In a case where the coefficient of dynamic friction is 0.20 or more, the abrasion resistance and roll followability are improved.

In a case where the coefficient of dynamic friction is 0.40 or less, the reduction in abrasion resistance is suppressed. In addition, image misregistration is also suppressed.

The coefficient of dynamic friction can be adjusted, for example, by the kind and amount of the inorganic particles.

The coefficient of dynamic friction is measured by a pin-on-disk method. Specifically, the method is as follows.

A test piece in which the layer configuration from the base material to the release layer is maintained is obtained from the fixing member to be measured.

A recording medium is placed on a disk of a wear tester (FPR-2100, RSK Co., Ltd.). As the recording medium, a recording medium having a thickness of 97 μm and a basis weight of 90 g/m² is used, that is pre-dried at 100° C. for 30 minutes.

The test piece is fixed to the recording medium on a pin side with a polyimide tape. As a result, the surface of the release agent of the test piece is brought into contact with the recording medium.

A vertical resistance of 0.5 kg/cm² is applied to a contact portion between the test piece and the recording medium.

The recording medium is moved at a speed of 54.8 mm/s in a surface direction of the contact portion between the test piece and the recording medium.

A dynamic friction force between the test piece and the recording medium is measured to obtain the coefficient of dynamic friction.

The operation is performed on 16 test pieces, and the obtained coefficients of dynamic friction are arithmetically averaged.

The measurement temperature and the measurement humidity are set to a temperature of 120° C. and a relative humidity of 55%.

### Vickers Hardness

A Vickers hardness of the release layer at 120° C., that is measured from a surface side of the release layer, is, for example, preferably 1.0 HV or more and 4.0 HV or less, more preferably 1.2 HV or more and 3.8 HV or less, and still more preferably 1.5 HV or more and 3.5 HV or less.

In a case where the Vickers hardness of the release layer is 1.0 HV or more, the abrasion resistance is improved.

In a case where the Vickers hardness of the release layer is 4.0 HV or less, the reduction in release properties is suppressed.

The Vickers hardness of the release layer can be adjusted, for example, by the kind and amount of the inorganic particles.

A method of measuring the Vickers hardness is as follows.

A test piece in which the layer configuration from the base material to the release layer is maintained is obtained from the fixing member to be measured.

The Vickers hardness is measured by a nanoindentation method using a nanoindenter from the surface side of the release layer of the test piece. Specifically, a Vickers hardness (HV_{C}) is calculated from a nanoindentation hardness (H_{IT}) in a case where a Vickers indenter is pushed into the release layer to a depth of 1.5 μm at 1.2 mN and held for 10 seconds, using the following expression.

$${HV}_{C} = 0.9269 \times {H}_{IT} \qquad Expression$$

The operation is performed on 7 test pieces, and the obtained Vickers hardnesses are arithmetically averaged.

Here, the measurement conditions are as follows.

Measurement temperature and measurement humidity: under temperature of 120° C. and relative humidity of 55%

### Elastic Deformation Rate

An elastic deformation rate of the release layer at 120° C., that is measured from a surface side of the release layer, is, for example, preferably 60% or more, more preferably 65% or more, and still more preferably 70% or more.

In a case where the elastic deformation rate of the release layer is 60% or more, the abrasion resistance is improved.

Here, from the viewpoint of pressure holding during nip formation with a facing member, the elastic deformation rate of the release layer is, for example, preferably 95% or less, and more preferably 90% or less.

The elastic deformation rate of the release layer can be adjusted, for example, by the kind and amount of the inorganic particles.

A method of measuring the elastic deformation rate is as follows.

A test piece in which the layer configuration from the base material to the release layer is maintained is obtained from the fixing member to be measured.

The elastic deformation rate is measured by a nanoindentation method using a nanoindenter from the surface side of the release layer of the test piece.

Specifically, a sapphire needle is pushed into the release layer to a depth of 1.5 μm at 1.2 mN, a displacement amount to a load peak and a displacement recovery amount after the load is released are measured, and a ratio of the displacement amount to the displacement recovery amount is defined as the elastic deformation rate.

The operation is performed on 7 test pieces, and the obtained elastic deformation rates are arithmetically averaged.

### Water Contact Angle

A water contact angle on the surface of the release layer is, for example, preferably 90° or more, more preferably 95° or more, and still more preferably 100° or more.

In a case where the water contact angle is 90° or more, the release properties are improved.

The water contact angle can be adjusted, for example, by the kind and amount of the polysiloxane compound SQ.

A method of measuring the water contact angle is as follows.

A sample of the release layer is obtained.

In an environment of a temperature of 25° C. and a humidity of 50%, 10 μl of pure water is dropped onto a surface of the release layer of the sample using a contact angle meter (manufactured by Kyowa Interface Science Co., Ltd., model number: CA-X-FACE), and the liquid droplet 3 seconds after the dropping is imaged with an optical microscope. A water contact angle θ is obtained based on a θ/2 method from the obtained captured image.

The operation is performed on 5 test pieces, and the obtained water contact angles are arithmetically averaged.

### Method of Forming Release Layer

Examples of a method of forming the release layer include a method of forming the release layer by a coating method such as a blade coating method, a dip coating method, a spray coating method, a ring coating method, and a brush coating method.

The release layer is formed by applying a coating liquid containing the above-described components and a solvent as necessary onto the base material (or in a case where the functional layer such as the elastic layer is provided on the base material, onto the functional layer of the base material with the functional layer) by the above-described coating method, and drying or drying and curing the coating liquid. In a case where the polysiloxane compound has a reactive group, the reactive group is reacted by heating or irradiation with ultraviolet rays after drying to cure the coating liquid, thereby forming the release layer.

In the method of forming the release layer, as the coating method, for example, a blade coating method, a dip coating method, a spray coating method, or a ring coating method is preferable.

Here, in the blade coating method, a spiral streak (also referred to as “spiral trace”) is generated by spreading the coating liquid with a metal plate (that is, a blade). In the dip coating method or the ring coating method, a film thickness difference in an axial direction occurs due to liquid dripping. In the spray coating method, a surface roughness in a pear skin shape occurs due to coating unevenness. In this way, the release layer is likely to have coating defects.

However, in a case where the coating liquid containing the above-described components and a solvent as necessary is used and these coating methods are applied, a release layer having reduced coating defects can be formed.

In a case where the blade coating method is applied, the release layer is formed as follows, for example.

(1) The base material (or the base material with the functional layer) is fixed to an outer peripheral surface of a cylindrical mold having a width longer than the base material.

(2) A coating device that discharges the coating liquid is moved relative to the cylindrical mold along an axial direction of the mold at a target coating speed in a state in which the axial direction of the mold is along the horizontal direction while rotating the cylindrical mold in a circumferential direction, and the coating liquid is continuously applied onto the base material.

(3) A metal plate (that is, a blade) having a width shorter than the base material is moved along the axial direction at the same speed as the coating speed of the coating device in a state of being brought into contact with the coating liquid applied onto the base material to spread the coating liquid.

(4) The spread coating film of the coating liquid is dried or dried and cured to form the release layer.

In a case where the dip coating method is applied, the release layer is formed as follows, for example.

(1) The base material (or the base material with the functional layer) is fixed to an outer peripheral surface of a cylindrical mold having a width longer than the base material.

(2) The coating liquid is filled in a cylindrical container having a bottom, and the base material fixed to the cylindrical mold is dipped in the coating liquid.

(3) The dipped base material is pulled up to apply the coating liquid onto the base material.

(4) The coating film of the coating liquid is dried or dried and cured to form the release layer.

In a case where the spray coating method is applied, the release layer is formed as follows, for example.

(1) The base material (or the base material with the functional layer) is fixed to an outer peripheral surface of a cylindrical mold having a width longer than the base material.

(2) A coating device that sprays the coating liquid is moved relative to the cylindrical mold along an axial direction of the mold at a target coating speed in a state in which the axial direction of the mold is along the horizontal direction while rotating the cylindrical mold in a circumferential direction, and the coating liquid is applied onto the base material.

(3) The coating liquid is applied in a plurality of layers by repeating reciprocating movement of the coating device in the axial direction of the mold while spraying the coating liquid from the coating device to obtain a coating film.

(4) The coating film of the coating liquid is dried or dried and cured to form the release layer.

In a case where the ring coating method is applied, the release layer is formed as follows, for example.

(1) The base material (or the base material with the functional layer) is fixed to an outer peripheral surface of a cylindrical mold having a width longer than the base material.

(2) The base material fixed to the cylindrical mold is inserted into a base material insertion portion of a ring-shaped coating device until the base material is exposed from the base material insertion portion in a state in which an axial direction of the mold is along the vertical direction and the base material is coaxial with the base material insertion portion; the coating liquid is discharged from a side surface of the base material insertion portion of the ring-shaped coating device while moving the ring-shaped coating device and the base material relative to each other in the base material axial direction to apply the coating liquid onto the base material;
here, as the ring-shaped coating device, for example, a coating device in which a resin sheet having a hole is fixed to a bottom surface of a cylindrical metal container having a hole in the bottom surface, the resin sheet being coaxial with the hole of the cylindrical metal container, with a gap is applied; the bottom surface of the cylindrical metal container and the hole of the resin sheet are the base material insertion portion; the coating liquid is poured between the bottom surface of the ring-shaped coating device and the resin sheet to discharge the coating liquid from the side surface of the base material insertion portion.

(3) The coating film of the coating liquid is dried or dried and cured to form the release layer.

In a case where the brush coating method is applied, the release layer is formed as follows, for example.

(1) The base material (or the base material with the functional layer) is fixed to an outer peripheral surface of a cylindrical mold having a width longer than the base material.

(2) A brush having a width larger than the base material and impregnated with the coating liquid is brought into contact with the base material while moving the brush relative to the mold along an axial direction of the mold at a target coating speed in a state in which the axial direction of the mold is along a horizontal direction while rotating the cylindrical mold in a circumferential direction, and the coating liquid is applied onto the base material.

(3) The coating liquid is applied in a plurality of layers by repeating reciprocating movement of the brush in the axial direction of the mold to obtain a coating film.

(4) The coating film of the coating liquid is dried or dried and cured to form the release layer.

### Application of Fixing Member

The fixing member according to the present exemplary embodiment is applied to, for example, both a heating member and a pressurizing member. The heating member may be any of a heating member heated by an electromagnetic induction method or a heating member heated from an external heat source.

However, in a case where the fixing member according to the present exemplary embodiment is applied to the heating member heated by an electromagnetic induction method, for example, a metal layer (heat generation layer) that generates heat by electromagnetic induction may be provided.

In a case where the fixing member according to the present exemplary embodiment is applied to the heating member, since the release properties are high, contamination of an image forming surface of the recording medium is suppressed.

In a case where the fixing member according to the present exemplary embodiment is applied to the pressurizing member, since the release properties are high, contamination of a back surface of the recording medium is suppressed. In addition, the followability is improved, and the image misregistration is also suppressed.

### Fixing Device

The fixing device according to the present exemplary embodiment includes a first rotating body and a second rotating body disposed in contact with an outer surface of the first rotating body, in which at least one of the first rotating body or the second rotating body is constituted of the fixing member according to the present exemplary embodiment described above.

Hereinafter, regarding the fixing device according to the present exemplary embodiment, a fixing device including a heating roll and a pressurizing belt will be described as a first exemplary embodiment; and a fixing device including a heating belt and a heating roll will be described as a second exemplary embodiment.

The fixing device according to the present exemplary embodiment is not limited to the first and second embodiments, and may be a fixing device including a heating roll and a pressurizing roll or a fixing device including a heating belt and a pressurizing belt.

In the fixing device according to the present exemplary embodiment, the fixing member according to the present exemplary embodiment may be applied to any of the heating roll, the heating belt, the pressurizing roll, or the pressurizing belt.

As the fixing device according to the present exemplary embodiment, a well-known fixing device such as an electromagnetic induction heating method can also be applied.

### First Exemplary Embodiment of Fixing Device

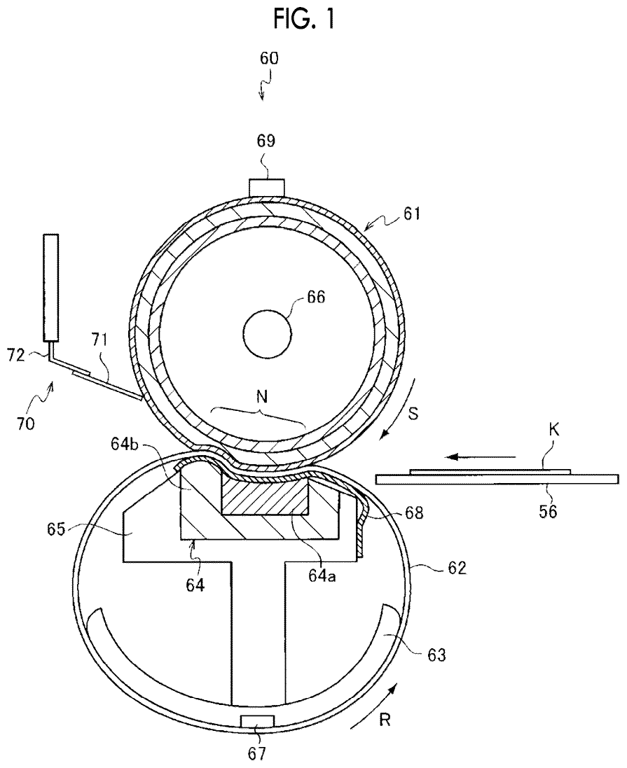

The first exemplary embodiment of the fixing device will be described with reference to FIG. 1. FIG. 1 is a schematic view showing an example of the first exemplary embodiment of the fixing device.

The example of the fixing device according to the present exemplary embodiment will be described with reference to FIG. 1. FIG. 1 is a view schematically showing an example of the fixing device according to the present exemplary embodiment.

As shown in FIG. 1, the fixing device 60 includes, for example, a heating roll 61 that is rotationally driven, a pressurizing belt 62, and a pressing pad 64 that presses the heating roll 61 through the pressurizing belt 62.

The heating roll 61 is an example of a first rotating body. The pressurizing belt 62 is an example of a second rotating body.

The pressing pad 64 is a pad that presses the heating roll 61 through the pressurizing belt 62, and is an example of a pressing member.

Regarding the pressing pad 64, for example, the pressurizing belt 62 and the heating roll 61 may be relatively pressed. Therefore, the pressurizing belt 62 may be pressed against the heating roll 61, or the heating roll 61 may be pressed against the pressurizing belt 62.

A halogen lamp 66 (an example of a heating device) is disposed inside the heating roll 61. The heating device is not limited to the halogen lamp, and other heating members that generate heat may be used.

Meanwhile, for example, a temperature-sensitive element 69 is disposed in contact with a surface of the heating roll 61. The lighting of the halogen lamp 66 is controlled based on a temperature measurement value by the temperature-sensitive element 69, and a surface temperature of the heating roll 61 is kept at a target set temperature (for example, 150° C.).

For example, the pressurizing belt 62 is rotatably supported by the pressing pad 64 and a belt traveling guide 63 that are disposed inside the pressurizing belt 62. In a sandwiching region N (nip portion), the pressurizing belt 62 is disposed to be pressed against the heating roll 61 by the pressing pad 64.

The pressing pad 64 is, for example, disposed in a state of being pressed against the heating roll 61 through the pressurizing belt 62 inside the pressurizing belt 62, and forms the sandwiching region N with the heating roll 61.

In the pressing pad 64, for example, a front sandwiching member 64a for securing a wide sandwiching region N is disposed on the inlet side of the sandwiching region N, and a peeling sandwiching member 64b for imparting distortion to the heating roll 61 is disposed on the outlet side of the sandwiching region N.

A sheet-shaped sliding member 68 is provided on a surface of the front sandwiching member 64a and the peeling sandwiching member 64b that is in contact with the pressurizing belt 62. The sliding member 68 reduces a sliding resistance between an inner peripheral surface of the pressurizing belt 62 and the pressing pad 64. The pressing pad 64 and the sliding member 68 are held by a metal holding member 65.

The sliding member 68 is provided, for example, such that a sliding surface thereof is in contact with the inner peripheral surface of the pressurizing belt 62. The sliding member 68 is involved in holding and supplying oil present between the sliding member 68 and the pressurizing belt 62.

For example, the belt traveling guide 63 is attached to the holding member 65. The pressurizing belt 62 is configured to be guided by the belt traveling guide 63 to rotate.

A lubricant supply device 67 that supplies a lubricant (oil) to the inner peripheral surface of the pressurizing belt 62 is attached to the belt traveling guide 63.

The heating roll 61 rotates in a direction of an arrow S by, for example, a drive motor (not shown). The pressurizing belt 62 rotates in a direction of an arrow R, opposite to the rotation direction of the heating roll 61, in response to the rotation of the heating roll 61. That is, for example, the heating roll 61 rotates clockwise in FIG. 1, while the pressurizing belt 62 rotates counterclockwise.

Paper K (an example of a recording medium) having an unfixed toner image is guided by, for example, a fixing inlet guide 56, and transported to the sandwiching region N. While the paper K is passing through the sandwiching region N, the unfixed toner image on the paper K is fixed by the pressure and heat acting on the sandwiching region N.

In the fixing device 60, for example, by the front sandwiching member 64a in the form of a recess conforming to an outer peripheral surface of the heating roll 61, the wide sandwiching region Nis secured, compared to a configuration having no front sandwiching member 64a.

In addition, in the fixing device 60, for example, the peeling sandwiching member 64b is disposed to protrude from the outer peripheral surface of the heating roll 61. The peeling sandwiching member 64b is configured such that the distortion of the heating roll 61 locally increases in an outlet region of the sandwiching region N.

In a case where the peeling sandwiching member 64b is disposed as described above, for example, the paper K after the fixing passes through the distortion formed locally large in a case of passing through the peeling sandwiching region, and thus the paper K is easily peeled off from the heating roll 61.

As an auxiliary device for the peeling, for example, a peeling member 70 is disposed on the downstream side of the sandwiching region N of the heating roll 61. The peeling member 70 is, for example, held by a holding member 72 in a state in which a peeling claw 71 is close to the heating roll 61 in a direction facing the rotation direction of the heating roll 61 (counter direction).

### Second Exemplary Embodiment of Fixing Device

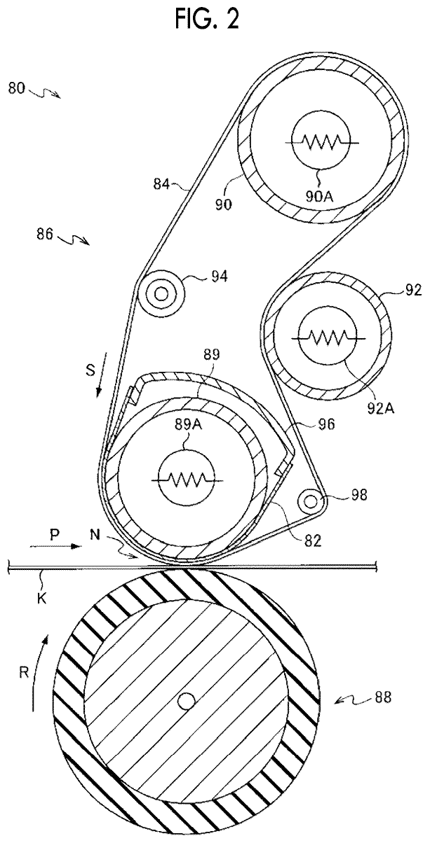

The second exemplary embodiment of the fixing device will be described with reference to FIG. 2. FIG. 2 is a schematic view showing an example of the second exemplary embodiment of the fixing device.

As shown in FIG. 2, the fixing device 80 includes, for example, a fixing belt module 86 including a heating belt 84 and a pressurizing roll 88 that is pressed and disposed on the heating belt 84 (that is, the fixing belt module 86). For example, a sandwiching region N (nip portion) is formed in a contact portion between the heating belt 84 (that is, the fixing belt module 86) and the pressurizing roll 88. In the sandwiching region N, paper K (an example of the recording medium) is pressed and heated, and the toner image is fixed.

The heating belt 84 is an example of the first rotating body. The pressurizing roll 88 is an example of the second rotating body.

The fixing belt module 86 includes, for example, an endless heating belt 84, a heating and pressurizing roll 89, and a support roll 90.

The heating and pressurizing roll 89 is a roll that is wound with the heating belt 84 on the pressurizing roll 88 side, is rotationally driven by a rotation force of a motor (not shown), and presses the heating belt 84 from an inner peripheral surface to the pressurizing roll 88 side.

The support roll 90 is a roll that supports the heating belt 84 from the inside at a position different from the heating and pressurizing roll 89.

The fixing belt module 86 is provided with, for example, a support roll 92, a posture correction roll 94, and a support roll 98.

The support roll 92 is a roll that is disposed outside the heating belt 84 and defines a circumferential path of the heating belt 84.

The posture correction roll 94 is a roll that corrects a posture of the heating belt 84 from the heating and pressurizing roll 89 to the support roll 90.

The support roll 98 is a roll that applies a tension to the heating belt 84 from an inner peripheral surface on a downstream side of the sandwiching region N formed by the heating belt 84 and the pressurizing roll 88.

The fixing belt module 86 is provided, for example, such that a sheet-shaped sliding member 82 is interposed between the heating belt 84 and the heating and pressurizing roll 89.

The sliding member 82 is provided, for example, such that a sliding surface thereof is in contact with the inner peripheral surface of the heating belt 84. The sliding member 82 is involved in holding and supplying oil present between the heating belt 84.

Here, the sliding member 82 is provided, for example, in a state in which both ends thereof are supported by a support member 96.

For example, a halogen heater 89A (an example of the heating device) is provided inside the heating and pressurizing roll 89.

The support roll 90 is, for example, a cylindrical roll. A halogen heater 90A (an example of the heating device) is disposed inside the support roll 90. The halogen heater 90A heats the heating belt 84 from the inner peripheral surface side.

At both ends of the support roll 90, for example, spring members (not shown) pressing the heating belt 84 outward are disposed.

The support roll 92 is, for example, a cylindrical roll. A release layer is formed on a surface of the support roll 92.

The release layer of the support roll 92 is formed, for example, for preventing a toner or paper dust from the outer peripheral surface of the heating belt 84 from accumulating on the support roll 92.

A halogen heater 92A (an example of the heating device) is disposed, for example, inside the support roll 92. The halogen heater 92A heats the heating belt 84 from the outer peripheral surface side.

That is, for example, the heating and pressurizing roll 89, the support roll 90, and the support roll 92 are configured to heat the heating belt 84.

The posture correction roll 94 is, for example, a cylindrical roll. A terminal position measurement mechanism (not shown) that measures a terminal position of the heating belt 84 is disposed in the vicinity of the posture correction roll 94.

For example, a shaft displacement mechanism (not shown) that displaces a contact position of the heating belt 84 in the axial direction in accordance with the measurement result of the terminal position measurement mechanism is disposed in the posture correction roll 94. The posture correction roll 94 is configured to control the meandering of the heating belt 84.

On the other hand, the pressurizing roll 88 is rotatably supported, for example. The pressurizing roll 88 is pressed, for example, by a biasing device such as a spring (not shown) at a portion where the heating belt 84 is wound around the heating and pressurizing roll 89.

The heating belt 84 (that is, the heating and pressurizing roll 89) of the fixing belt module 86 moves rotationally in the direction of the arrow S. Accordingly, the pressurizing roll 88 rotationally moves in the direction of the arrow R in response to the heating belt 84 (that is, the heating and pressurizing roll 89).

The paper K having an unfixed toner image (not shown) is transported in a direction of an arrow P and is guided to the sandwiching region N of the fixing device 80. While the paper K is passing through the sandwiching region N, the unfixed toner image on the paper K is fixed by the pressure and heat acting on the sandwiching region N.

In the fixing device 80, the form in which the halogen heater (halogen lamp) is applied as an example of the heating device has been described. However, the present invention is not limited thereto, and a radiation lamp heat generation element (a heat generation element that emits radiation (infrared rays or the like)) or a resistance heat generation element (a heat generation element that generates Joule heat by flowing a current through a resistance; for example, a heat generation element in which a film having a resistance is formed on a ceramic base material and is fired) may be applied instead of the halogen heater.

### Image Forming Apparatus

Next, the image forming apparatus according to the present exemplary embodiment will be described.

The image forming apparatus according to the present exemplary embodiment includes:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device that fixes the toner image on the surface of the recording medium.

As the fixing device, the fixing device according to the present exemplary embodiment is applied.

In the image forming apparatus according to the present exemplary embodiment, the fixing device may be made into each cartridge such that the fixing device is detachable from an image forming apparatus. That is, the image forming apparatus according to the present exemplary embodiment may include the fixing device according to the present exemplary embodiment, as a device configuring a process cartridge.

Hereinafter, the image forming apparatus according to the present exemplary embodiment will be described with reference to a drawing.

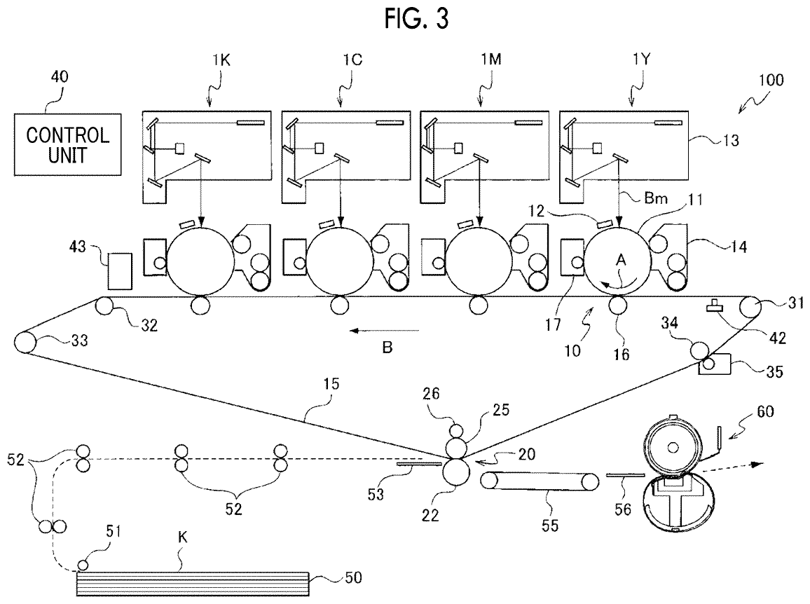

FIG. 3 is a schematic configuration view showing a configuration of the image forming apparatus according to the present exemplary embodiment.

As shown in FIG. 3, an image forming apparatus 100 according to the present exemplary embodiment is, for example, an intermediate transfer-type image forming apparatus generally called a tandem type.

The image forming apparatus 100 includes a plurality of image forming units 1Y, 1M, 1C, and 1K, an intermediate transfer belt 15, a primary transfer unit 10, a secondary transfer unit 20, and the fixing device 60. In addition, the image forming apparatus 100 includes a control unit 40 that controls the operation of each device (or each unit).

Here, the image forming units 1Y, 1M, 1C, and 1K are image forming units that form a toner image of each color component by an electrophotographic method.

The primary transfer unit 10 is a transfer unit that sequentially transfers (primary transfers) the toner image of each color component formed by the image forming units 1Y, 1M, 1C, and 1K to the intermediate transfer belt 15.

The secondary transfer unit 20 is a transfer unit that collectively transfers (secondary transfers) the superimposed toner images transferred to the intermediate transfer belt 15 to the paper K that is the recording medium.

The fixing device 60 is a device that fixes the image transferred by the secondary transfer to the paper K.

Each of the image forming units 1Y, 1M, 1C, and 1K of the image forming apparatus 100 includes a photoreceptor 11 that rotates in a direction of an arrow A, as an example of an image holder that holds a toner image formed on the surface.

Around the photoreceptor 11, a charger 12 that charges the photoreceptor 11 is provided as an example of the charging device. Around the photoreceptor 11, a laser exposure device 13 (exposure beam is indicated by a reference numeral Bm in the drawing) that writes an electrostatic latent image on the photoreceptor 11 is provided as an example of the electrostatic latent image forming device.

Around the photoreceptor 11, a developer 14 that accommodates the toner of each color component and visualizes the electrostatic latent image on the photoreceptor 11 with the toner is provided as an example of the developing device.

Around the photoreceptor 11, a primary transfer roll 16 that transfers the toner image of each color component formed on the photoreceptor 11 to the intermediate transfer belt 15 by the primary transfer unit 10 is provided.

Around the photoreceptor 11, a photoreceptor cleaner 17 that removes a residual toner on the photoreceptor 11 is provided.

The charger 12, the laser exposure device 13, the developer 14, the primary transfer roll 16, and the photoreceptor cleaner 17 are sequentially arranged around the photoreceptor 11 along the rotation direction of the photoreceptor 11.

These image forming units 1Y, 1M, 1C, and 1K are substantially linearly arranged in order of yellow (Y), magenta (M), cyan (C), and black (K) from the upstream side of the intermediate transfer belt 15.

By various rolls, the intermediate transfer belt 15 is driven to circulate (rotate) in the direction of an arrow B shown in FIG. 3 at a speed fit for the purpose.

The various rolls include a drive roll 31, a support roll 32, a tension applying roll 33, a back roll 25, and a cleaning back roll 34.

The drive roll 31 is a roll that is driven by a motor (not shown) having an excellent constant speed property and rotates the intermediate transfer belt 15.

The support roll 32 is a roll that supports the intermediate transfer belt 15 extending in a substantially linear shape along the arrangement direction of each photoreceptor 11.

The tension applying roll 33 is a roll that is provided in the secondary transfer unit 20, has a function of applying a tension to the intermediate transfer belt 15, and prevents the intermediate transfer belt 15 from meandering.

The cleaning back roll 34 is a roll that is provided in a cleaning portion that scrapes off the residual toner on the intermediate transfer belt 15.

The primary transfer unit 10 is configured with the primary transfer roll 16 that is disposed to face the photoreceptor 11 across the intermediate transfer belt 15.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically attracted to the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

In addition, an intermediate transfer belt cleaner 35 is provided on the downstream side of the secondary transfer unit 20 on the intermediate transfer belt 15 to be freely attachable to and detachable from the intermediate transfer belt 15.

The intermediate transfer belt cleaner 35 is a cleaner that removes the residual toner or paper powder on the intermediate transfer belt 15 after the secondary transfer, and cleans the surface of the intermediate transfer belt 15.

The intermediate transfer belt 15, the primary transfer unit 10 (primary transfer roll 16), and the secondary transfer unit 20 (secondary transfer roll 22) correspond to an example of the transfer device.

On the other hand, a reference sensor (home position sensor) 42 is disposed on an upstream side of the yellow image forming unit 1Y.

The reference sensor 42 is a sensor that generates a reference signal serving as a reference for taking an image forming timing in each of the image forming units 1Y, 1M, 1C, and 1K.

The reference sensor 42 recognizes a mark provided on a back side of the intermediate transfer belt 15 to generate the reference signal. Each of the image forming units 1Y, 1M, 1C, and 1K is configured to start the image formation in response to an instruction from the control unit 40 based on the recognition of the reference signal.

An image density sensor 43 used to adjust image quality is provided on the downstream side of the black image forming unit 1K.

The image forming apparatus 100 includes a paper accommodation unit 50, a paper feeding roll 51, a transport roll 52, a transport guide 53, a transport belt 55, and a fixing inlet guide 56.

The paper accommodation unit 50 is a storage unit that accommodates the paper K, as a transport device that transports the paper K.

The paper feeding roll 51 is a roll that takes out the paper K accumulated in the paper accommodation unit 50 at a predetermined timing, and transports the paper K.

The transport roll 52 is a roll that transports the paper K fed by the paper feeding roll 51.

The transport guide 53 is a guide that feeds the paper K transported by the transport roll 52 to the secondary transfer unit 20.

The transport belt 55 is a belt that transports the paper K, that is secondarily transferred by the secondary transfer roll 22, to the fixing device 60.

The fixing inlet guide 56 is a guide that guides the paper K to the fixing device 60.

Next, basic image forming process of the image forming apparatus 100 according to the present exemplary embodiment will be described.

In the image forming apparatus 100 according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. The image data that has been subjected to the image processing is converted into color material gradation data of four colors of yellow (Y), magenta (M), cyan (C), and black (K), and is output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors of yellow (Y), magenta (M), cyan (C), and black (K).

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport device, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. The paper K is temporarily stopped before reaching the secondary transfer unit 20. The position alignment roll (not shown) rotates in accordance with the movement timing of the intermediate transfer belt 15 on which the toner image is held, and the position of the paper K and the position of the toner image are aligned.

In the secondary transfer unit 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K on which the toner image is electrostatically transferred is transported as it is in a state of being peeled off from the intermediate transfer belt 15 by the secondary transfer roll 22. The paper K is transported to the transport belt 55 provided on a downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in an output portion of the image forming apparatus 100.

On the other hand, after the transfer to the paper K is completed, the residual toner remaining on the intermediate transfer belt 15 is transported to the cleaning unit with the rotation of the intermediate transfer belt 15. The residual toner is removed from the intermediate transfer belt 15 by the cleaning back roll 34 and the intermediate transfer belt cleaner 35.

Although the present exemplary embodiment has been described, the present exemplary embodiment is not limited to the above-described exemplary embodiments, and various modifications, changes, and ameliorations can be added thereto.

### EXAMPLES

Hereinafter, the present exemplary embodiment will be described in more detail with reference to Examples, but the present exemplary embodiment is not limited to Examples. In the following description, “part” represents “part by mass” unless otherwise specified.

### Example 1

A polyimide resin (hereinafter, “PI”) base material formed in an endless belt shape and having a diameter of 30 mm, a width of 243 mm, and a film thickness of 80 μm is prepared.

Next, a coating liquid having the following formulation is applied onto the PI base material, and the coating liquid is irradiated with ultraviolet rays to form a release layer having a thickness of 30 μm.

The formulation of the coating liquid is as follows.
Binding material: polysiloxane compound: “OX-SQ-SI20”, TOAGOSEI CO., LTD., polysiloxane compound having a T unit represented by the formula: [R¹SiO_{3/2}]ₘ (in the formula, R¹=a methyl group and an oxetanyl group) and a D unit represented by the formula: (R²R³SiO_{2/2})ₙ (in the formula, R² and R³=methyl groups): 90 parts
Inorganic particles: molybdenum disulfide particles (“Molypowder PA”, SUMICO LUBRICANT CO., LTD., average particle diameter=5 μm): 5 parts
Conductive material: carbon black (“DENKA BLACK”, Denka Company Limited): 5 parts

As a result of the above-described operation, an endless belt is obtained.

### Examples 2 to 16 and Comparative Examples 1 to 5

An endless belt is obtained in the same manner as in Example 1, except that the following items are changed according to Table 1. However, in Table 1, in an example in which SQ2 or SQ3 is used as the binding material, the release layer is formed by heating at 120° C. for 10 minutes and further heating at 170° C. for 10 minutes, instead of ultraviolet irradiation.
Kind and amount of binding material (amount is content with respect to release layer)
Kind and amount of inorganic particles (amount is content with respect to release layer)

### Example 17

A polyimide resin (hereinafter, “PI”) base material formed in an endless belt shape and having a diameter of 30 mm, a width of 243 mm, and a film thickness of 80 μm is prepared.

A mixture of 20 parts by mass of the polysiloxane compound, 5 parts by mass of the inorganic particles, and 5 parts by mass of the conductive material of the types shown in Table 1 is mixed with 70 parts by mass of a polyphenylene sulfide (PPS) resin as the binding material, and the mixture is molded by extrusion molding to obtain a tube having a thickness of 20 μm.

The obtained tube is coated on the PI base material, and fired at 200° C. for 1 hour to form a release layer.

### Evaluation of Characteristics

The following characteristics of the endless belt of each of Examples are measured by the above-described method.
Coefficient of dynamic friction of on surface of release layer with respect to recording medium
Vickers hardness of release layer at 120° C., that is measured from surface side of release layer
Elastic deformation rate of release layer at 120° C., that is measured from surface side of release layer
Water contact angle on surface of release layer

### Actual Machine Evaluation

Each of the endless belts of Examples is mounted on an evaluation image forming apparatus (“Apeos C 3530” manufactured by FUJIFILM Business Innovation Corp.) as a pressurizing belt of a fixing device.

The following evaluations are performed by the evaluation image forming apparatus.

### Evaluation of Contamination of Back Surface of Paper

1,000 black solid images are output onto A4 paper from the evaluation image forming apparatus. Contamination of a back surface of the paper is evaluated according to the following standard.
A+: proportion of paper on which back surface contamination is confirmed is less than 0.5%.
A: proportion of paper on which back surface contamination is confirmed is 0.5% or more and less than 1%.
B: proportion of paper on which back surface contamination is confirmed is 1% or more and less than 5%.
C: proportion of paper on which back surface contamination is confirmed is 5% or more.

### Evaluation of Roll Followability

In the evaluation image forming apparatus, the fixing device is driven without paper passing to idle the pressurizing belt and the heating roll. A slip rate is obtained from a rotation speed of the pressurizing belt and a rotation speed of the heating roll at that time by the following expression. Evaluation is performed based on the following evaluation standard.

$$Slip rate = ( Rotation speed of heating roll - Rotation speed of pressurizing belt ) / Rotation speed of heating roll \times 100$$

A+: slip rate of heating roll with respect to pressurizing belt is 5% or less.
A: slip rate of heating roll with respect to pressurizing belt is 5% or more and less than 10%.
B: slip rate of heating roll with respect to pressurizing belt is 10% or more and less than 20%.
C: slip rate of heating roll with respect to pressurizing belt is 20% or more.

### Evaluation of Image Misregistration

1,000 chart images are output onto A4 paper from the evaluation image forming apparatus. Image misregistration due to paper transport failure is evaluated according to the following standard.
A+: proportion of paper on which image misregistration is confirmed is less than 0.5%.
A: proportion of paper on which image misregistration is confirmed is 0.5% or more and less than 1%.
B: proportion of paper on which image misregistration is confirmed is 1% or more and less than 5%.
C: proportion of paper on which image misregistration is confirmed is 5% or more.

### Abrasion Resistance

100,000 black halftone images are output onto A4 paper from the evaluation image forming apparatus, and a film thickness of the release agent of the pressurizing belt is measured. Abrasion resistance of the pressurizing belt is evaluated according to the following standard.
A+: abrasion amount of release layer of pressurizing belt is less than 10 μm.
A: abrasion amount of release layer of pressurizing belt is 10 μm or more and less than 15 μm.
B: abrasion amount of release layer of pressurizing belt is 15 μm or more and less than 20 μm.
C: abrasion amount of release layer of pressurizing belt is 20 μm or more.

### Used Materials

Details of the materials used in each example are as follows.
SQ1: “OX-SQ-SI20”, TOAGOSEI CO., LTD., polysiloxane compound having a T unit represented by the formula: [R¹SiO_{3/2}]ₘ (in the formula, R¹=a methyl group and an oxetanyl group) and a D unit represented by the formula: (R²R³SiO_{2/2})ₙ (in the formula, R² and R³=methyl groups)
SQ2: “SR-13H”, KONISHI CHEMICAL IND CO., LTD., polysiloxane compound having only T unit represented by the formula [R¹SiO_{3/2}]ₘ (in the formula, R¹=a methyl group)
SQ3: “SR-23”, KONISHI CHEMICAL IND CO., LTD., polysiloxane compound having only T unit represented by the formula [R¹SiO_{3/2}]ₘ (in the formula, R¹=a phenyl group)
SQ4: “Gransil PSQ”, Grant Industries, Inc., particles of a polysiloxane compound having only T unit represented by the formula: [R¹SiO_{3/2}]ₘ (in the formula, R¹=a methyl group), volume average particle diameter: 4 to 6 μm
Molybdenum disulfide particles 1: (“Molypowder PA”, SUMICO LUBRICANT CO., LTD., average particle diameter=5 μm)
Molybdenum disulfide particles 2: (fractionated product obtained by fractionating “Molypowder PB” of SUMICO LUBRICANT CO., LTD. with a filter, average particle diameter=approximately 15 μm)
Molybdenum disulfide particles 3: (fractionated product obtained by fractionating “Molypowder PB” of SUMICO LUBRICANT CO., LTD. with a filter, average particle diameter=11 μm)
Molybdenum disulfide particles 4: (fractionated product obtained by fractionating “Molypowder PB” of SUMICO LUBRICANT CO., LTD. with a filter, average particle diameter=approximately 10 μm)
Molybdenum disulfide particles 5: (“Molypowder PS”, SUMICO LUBRICANT CO., LTD., average particle diameter=approximately 1 μm)
Molybdenum disulfide particles 6: (“A POWDER”, DAIZO CORPORATION, average particle diameter=0.8 μm)
Molybdenum disulfide particles 7: (“Molypowder PB”, SUMICO LUBRICANT CO., LTD., average particle diameter=17 μm)
Molybdenum disulfide particles 8: (“M-5 POWDER”, DAIZO CORPORATION, average particle diameter=0.4 μm)
Mica particles: (“A-11”, YAMAGUCHI MICA CO., LTD., average particle diameter=4 μm)
Barium sulfate particles: (“B-2”, SAKAI CHEMICAL INDUSTRY CO., LTD., average particle diameter=2 μm)
Silica particles: (“SEAHOSTAR KE-S150”, NIPPON SHOKUBAI CO., LTD., average particle diameter=2 μm)
Silicone resin: (“KR-5235”, Shin-Etsu Chemical Co., Ltd.)
Carbon black (conductive material): (“DENKA BLACK”, Denka Company Limited)

TABLE 1

| | | | Additive | | | | | | |
|---|---|---|---|---|---|---|---|---|---|
| | | | Polysiloxane | | | | | | |
| | Binding material | | compound | | Inorganic particles | | | Conductive material | |
| | | Amount | | Amount | | Average | Amount | | Amount |
| | | Part | | Part | | particle | Part | | Part |
| | | by | | by | | diameter | by | | by |
| | Type | mass | Type | mass | Type | μm | mass | Type | mass |
| Examples 1 | SQ1 | 90 | — | — | Molybdenum | 5 | 5 | Carbon | 5 |
| | | | | | disulfide particles 1 | | | black | |
| Examples 2 | SQ1 | 90 | — | — | Silica particles | 5 | 5 | Carbon | 5 |
| | | | | | | | | black | |
| Examples 3 | SQ1 | 90 | — | — | Molybdenum | 15 | 5 | Carbon | 5 |
| | | | | | disulfide particles 2 | | | black | |
| Examples 4 | SQ1 | 90 | — | — | Molybdenum | 11 | 5 | Carbon | 5 |
| | | | | | disulfide particles 3 | | | black | |
| Examples 5 | SQ1 | 90 | — | — | Molybdenum | 10 | 5 | Carbon | 5 |
| | | | | | disulfide particles 4 | | | black | |
| Examples 6 | SQ1 | 90 | — | — | Molybdenum | 1 | 5 | Carbon | 5 |
| | | | | | disulfide particles 5 | | | black | |
| Examples 7 | SQ1 | 90 | — | — | Molybdenum | 0.8 | 5 | Carbon | 5 |
| | | | | | disulfide particles 6 | | | black | |
| Examples 8 | SQ1 | 94.2 | — | — | Molybdenum | 5 | 0.8 | Carbon | 5 |
| | | | | | disulfide particles 1 | | | black | |
| Examples 9 | SQ1 | 94.1 | — | — | Molybdenum | 5 | 0.9 | Carbon | 5 |
| | | | | | disulfide particles 1 | | | black | |
| Examples 10 | SQ1 | 92 | — | — | Molybdenum | 5 | 3 | Carbon | 5 |
| | | | | | disulfide particles 1 | | | black | |
| Examples 11 | SQ1 | 88 | — | — | Molybdenum | 5 | 7 | Carbon | 5 |
| | | | | | disulfide particles 1 | | | black | |
| Examples 12 | SQ1 | 84 | — | — | Molybdenum | 5 | 11 | Carbon | 5 |
| | | | | | disulfide particles 1 | | | black | |
| Examples 13 | SQ1 | 83 | — | — | Molybdenum | 5 | 12 | Carbon | 5 |
| | | | | | disulfide particles 1 | | | black | |
| Examples 14 | SQ2 | 90 | — | — | Mica particles | 4 | 5 | Carbon | 5 |
| | | | | | | | | black | |
| Examples 15 | SQ3 | 90 | — | — | Barium sulfate | 2 | 5 | Carbon | 5 |
| | | | | | particles | | | black | |
| Examples 16 | SQ1 | 93 | — | — | Mica particles | 4 | 7 | — | — |
| Examples 17 | PPS | 70 | SQ4 | 20 | Mica particles | 4 | 5 | Carbon | 5 |
| | | | | | | | | black | |
| Comparative | Silicone | 95 | — | — | — | — | — | Carbon | 5 |
| Example 1 | resin | | | | | | | black | |
| Comparative | Silicone | 90 | — | — | Barium sulfate | 2 | 5 | Carbon | 5 |
| Example 2 | resin | | | | particles | | | black | |
| Comparative | SQ1 | 95 | — | — | — | — | — | Carbon | 5 |
| Example 3 | | | | | | | | black | |
| Comparative | SQ1 | 90 | — | — | Molybdenum | 17 | 5 | Carbon | 5 |
| Example 4 | | | | | disulfide particles 7 | | | black | |
| Comparative | SQ1 | 90 | — | — | Molybdenum | 0.4 | 5 | Carbon | 5 |
| Example 5 | | | | | disulfide particles 8 | | | black | |

| | Property evaluation | | | | Actual machine evaluation | | | |
|---|---|---|---|---|---|---|---|---|
| | Coefficient | | Elastic | Water | Contamination | | | |
| | of dynamic | Vickers | deformation | contact | of back | | | |
| | friction | hardness | rate | angle | surface of | Roll | Image | Abrasion |
| | — | — | % | ° | paper | followability | misregistration | resistance |
| Examples 1 | 0.27 | 2.8 | 77% | 107 | A+ | A+ | A+ | A+ |
| Examples 2 | 0.44 | 2.7 | 77% | 84 | B | A | B | B |
| Examples 3 | 0.45 | 4.1 | 59% | 88 | B | A | B | B |
| Examples 4 | 0.41 | 3.5 | 70% | 92 | A | A | B | B |
| Examples 5 | 0.37 | 3.2 | 71% | 95 | A | A | A | A |
| Examples 6 | 0.3 | 1.2 | 80% | 110 | A | A | A | A |
| Examples 7 | 0.39 | 0.9 | 82% | 108 | A | A | A | B |
| Examples 8 | 0.42 | 0.9 | 82% | 111 | A | A | B | B |
| Examples 9 | 0.41 | 1.1 | 81% | 110 | A | A | B | A |
| Examples 10 | 0.36 | 2.4 | 79% | 109 | A | A | A | A |
| Examples 11 | 0.25 | 3.2 | 72% | 104 | A | A | A | A |
| Examples 12 | 0.19 | 4 | 60% | 100 | A | B | A | A |
| Examples 13 | 0.18 | 4.3 | 58% | 97 | A | B | A | B |
| Examples 14 | 0.33 | 3.1 | 74% | 105 | A+ | A+ | A+ | A+ |
| Examples 15 | 0.31 | 2.6 | 76% | 106 | A+ | A+ | A+ | A+ |
| Examples 16 | 0.35 | 3.9 | 70% | 104 | A | A | A | A |
| Examples 17 | 0.33 | 2 | 81% | 109 | A | A | A | A |
| Comparative | 0.48 | 3 | 45% | 90 | B | A | C | B |
| Example 1 | | | | | | | | |
| Comparative | 0.34 | 4.5 | 41% | 79 | C | A | A | C |
| Example 2 | | | | | | | | |
| Comparative | 0.17 | 0.4 | 92% | 120 | A | C | A | C |
| Example 3 | | | | | | | | |
| Comparative | 0.47 | 4.8 | 51% | 75 | C | A | C | C |
| Example 4 | | | | | | | | |
| Comparative | 0.33 | 0.5 | 84% | 107 | A | A | A | C |
| Example 5 | | | | | | | | |

From the above results, it is found that, in the present example, the contamination of the back surface of the paper is suppressed and the abrasion resistance is excellent as compared with Comparative Examples.

As a result, it is found that the fixing member of the present example has excellent release properties and abrasion resistance.

In addition, it is found that the fixing member of the present example has excellent followability and suppressed image misregistration.

### Examples 101 to 125 and Comparative Examples 101 to 105

A coating film is formed by applying a coating liquid for forming a release layer according to Table 2 by a coating method, and the coating film is dried and cured to form a release layer. An endless belt is obtained in the same manner as in the example to which the formulation of the coating liquid for forming the release layer is applied, except for the above.

However, in Table 2, in the column of the coating method, examples in which the coating speed is set to 50 mm/min as the condition of the blade coating method are indicated as “A”, and examples in which the coating speed is set to 200 mm/min are indicated as “B”.

### Property Evaluation/Actual Machine Evaluation

As a result of property evaluation/actual machine evaluation of the endless belt of each example, the same evaluation results as in the example to which the formulation of the coating liquid for forming a release layer is applied are obtained.

### Coating Defects of Release Layer

Coating defects of the release layer of the endless belt of each example is evaluated as follows.

### Spiral Trace

A surface of the release layer is visually observed and evaluated according to the following standard.
A+: spiral trace is not visible at all.
A: faint spiral trace is visible.
B: clear spiral trace is visible in a part.
C: clear spiral trace is visible in the entire part.

### Drip

A film thickness difference A of the release layer at a position 40 mm inward in the axial direction from both end parts is measured and evaluated according to the following standard.
A+: film thickness difference A is 0 μm or more and 5 μm or less.
A: film thickness difference A is more than 5 μm and 10 μm or less.
B: film thickness difference A is more than 10 μm and 15 μm or less.
C: film thickness difference A is more than 15 μm.

### Surface Roughness

A surface of the release layer is visually observed and evaluated according to the following standard.
A+: no roughness in the pear skin is visible.
A: faint roughness in the pear skin is visible.
B: clear roughness in the pear skin is visible in a part.
C: clear roughness in the pear skin is visible in the entire part.

### Coating Streaks

A surface of the release layer is visually observed and evaluated according to the following standard.
A+: no coating streaks are visible.
A: faint coating streaks are visible.
B: clear coating streaks are visible in a part.
C: clear coating streaks are visible in the entire part.

TABLE 2

| | | | | Surface property evaluation of release layer | | | |
|---|---|---|---|---|---|---|---|
| | Formulation of coating liquid for | | | Spiral | | Surface | Coating |
| | forming release layer | Coating method | | trace | Drip | roughness | streaks |
| Examples 101 | Formulation same as in Example 1 | Blade coating | A | A+ | A+ | A+ | A+ |
| | | method | | | | | |
| Examples 102 | Formulation same as in Example 2 | Blade coating | A | A+ | A+ | A+ | A+ |
| | | method | | | | | |
| Examples 103 | Formulation same as in Example 3 | Blade coating | A | A+ | A+ | A+ | A+ |
| | | method | | | | | |
| Examples 104 | Formulation same as in Example 4 | Blade coating | A | A+ | A+ | A+ | A+ |
| | | method | | | | | |
| Examples 105 | Formulation same as in Example 5 | Blade coating | A | A+ | A+ | A+ | A+ |
| | | method | | | | | |
| Examples 106 | Formulation same as in Example 6 | Blade coating | A | A+ | A+ | A+ | A+ |
| | | method | | | | | |
| Examples 107 | Formulation same as in Example 7 | Blade coating | A | A+ | A+ | A+ | A+ |
| | | method | | | | | |
| Examples 108 | Formulation same as in Example 8 | Blade coating | A | A+ | A | A+ | A+ |
| | | method | | | | | |
| Examples 109 | Formulation same as in Example 9 | Blade coating | A | A+ | A | A+ | A+ |
| | | method | | | | | |
| Examples 110 | Formulation same as in Example 10 | Blade coating | A | A+ | A | A+ | A+ |
| | | method | | | | | |
| Examples 111 | Formulation same as in Example 11 | Blade coating | A | A | A+ | A | A+ |
| | | method | | | | | |
| Examples 112 | Formulation same as in Example 12 | Blade coating | A | A | A+ | A | A+ |
| | | method | | | | | |
| Examples 113 | Formulation same as in Example 13 | Blade coating | A | A | A+ | A | A+ |
| | | method | | | | | |
| Examples 114 | Formulation same as in Example 14 | Blade coating | A | A+ | A+ | A+ | A+ |
| | | method | | | | | |
| Examples 115 | Formulation same as in Example 15 | Blade coating | A | A+ | A+ | A+ | A+ |
| | | method | | | | | |
| Examples 116 | Formulation same as in Example 16 | Blade coating | A | A+ | A | A+ | A+ |
| | | method | | | | | |
| Examples 117 | Formulation same as in Example 17 | Blade coating | A | A | A+ | A | A+ |
| | | method | | | | | |
| Examples 118 | Formulation same as in Example 1 | Blade coating | B | B | A+ | A | A+ |
| | | method | | | | | |
| Examples 119 | Formulation same as in Example 1 | Dip coating method | | A+ | A+ | A | A+ |
| Examples 120 | Formulation same as in Example 8 | | | A+ | B | A+ | A+ |
| Examples 121 | Formulation same as in Example 1 | Spray coating method | | A+ | A | A+ | A+ |
| Examples 122 | Formulation same as in Example 13 | | | A+ | A+ | B | A+ |
| Examples 123 | Formulation same as in Example 1 | Ring coating method | | A+ | A+ | A | A+ |
| Examples 124 | Formulation same as in Example 8 | | | A+ | B | A+ | A+ |
| Comparative | Formulation same as in Comparative | Blade coating | A | A | B | A | A |
| Example 101 | Example 1 | method | | | | | |
| Comparative | Formulation same as in Comparative | Blade coating | A | B | A | B | B |
| Example 102 | Example 2 | method | | | | | |
| Comparative | Formulation same as in Comparative | Blade coating | A | A | B | A | A |
| Example 103 | Example 3 | method | | | | | |
| Comparative | Formulation same as in Comparative | Blade coating | A | B | A | B | B |
| Example 104 | Example 4 | method | | | | | |
| Comparative | Formulation same as in Comparative | Blade coating | A | B | A | B | B |
| Example 105 | Example 5 | method | | | | | |
| Examples 125 | Formulation same as in Example 1 | Brush coating method | | A | B | B | C |

From the above results, it is found that, in a case where the release layer is formed by the blade coating method, the dip coating method, the spray coating method, or the ring coating method using the coating liquid having the formulation of the release layer of the present example, a release layer with reduced coating defects can be formed compared to Comparative Examples or a case in which the brush coating method is applied.

The present exemplary embodiments include the following aspects.

(((1)))

A fixing member comprising:
a base material; and
a release layer that is provided on the base material and contains a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group) and inorganic particles having an average particle diameter of 0.5 μm or more and 15 μm or less.

(((2)))

The fixing member according to (((1))),
wherein the average particle diameter of the inorganic particles is 1 μm or more and 10 μm or less.

(((3)))

The fixing member according to (((1))) or (((2))
wherein the inorganic particles are at least one kind of particles selected from the group consisting of molybdenum disulfide, mica, and barium sulfate.

(((4))

The fixing member according to (((3))),
wherein the inorganic particles are the molybdenum disulfide.

(((5)))

The fixing member according to any one of (((1))) to (((4))),
wherein a content of the inorganic particles with respect to the release layer is 0.9% by mass or more and 11% by mass or less.

(((6)))
The fixing member according to (((5))),
wherein the content of the inorganic particles with respect to the release layer is 3% by mass or more and 7% by mass or less.

(((7))

The fixing member according to any one of (((1))) to (((6))),
wherein a coefficient of dynamic friction on a surface of the release layer with respect to a recording medium is 0.2 or more and 0.4 or less.

(((8)))

The fixing member according to any one of (((1))) to (((7))),
wherein a Vickers hardness of the release layer at 120° C., that is measured from a surface side of the release layer, is 1.0 HV or more and 4.0 HV or less.

(((9)))

The fixing member according to any one of (((1))) to (((8))),
wherein an elastic deformation rate of the release layer at 120° C., that is measured from a surface side of the release layer, is 60% or more.

(((10)))

The fixing member according to any one of (((1))) to (((9))),
wherein a water contact angle on a surface of the release layer is 90° or more.

(((11)))

A fixing device comprising:
a first rotating body; and
a second rotating body disposed in contact with an outer surface of the first rotating body,
wherein at least one of the first rotating body or the second rotating body is the fixing member according to any one of (((1))) to (((10))).

(((12)))

An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to (((11))), that fixes the toner image on the surface of the recording medium.

(((13))) A method of forming the release layer of the fixing member according to any one of (((1))) to (((10))), the method comprising:
forming the release layer by a blade coating method.

(((14))) A method of forming the release layer of the fixing member according to any one of (((1))) to (((10))), the method comprising:
forming the release layer by a dip coating method.

(((15))) A method of forming the release layer of the fixing member according to any one of (((1))) to (((10))), the method comprising:
forming the release layer by a spray coating method.

(((16))) A method of forming the release layer of the fixing member according to any one of (((1)) to (((10))), the method comprising:
forming the release layer by a ring coating method.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing member comprising:
a base material; and
a release layer that is provided on the base material and contains a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group) and inorganic particles having an average particle diameter of 0.5 μm or more and 15 μm or less.

2. The fixing member according to claim 1,
wherein the average particle diameter of the inorganic particles is 1 μm or more and 10 μm or less.

3. The fixing member according to claim 1,
wherein the inorganic particles are at least one kind of particles selected from the group consisting of molybdenum disulfide, mica, and barium sulfate.

4. The fixing member according to claim 3,
wherein the inorganic particles are the molybdenum disulfide.

5. The fixing member according to claim 1,
wherein a content of the inorganic particles with respect to the release layer is 0.9% by mass or more and 11% by mass or less.

6. The fixing member according to claim 5,
wherein the content of the inorganic particles with respect to the release layer is 3% by mass or more and 7% by mass or less.

7. The fixing member according to claim 1,
wherein a coefficient of dynamic friction on a surface of the release layer with respect to a recording medium is 0.2 or more and 0.4 or less.

8. The fixing member according to claim 1,
wherein a Vickers hardness of the release layer at 120° C., that is measured from a surface side of the release layer, is 1.0 HV or more and 4.0 HV or less.

9. The fixing member according to claim 1,
wherein an elastic deformation rate of the release layer at 120° C., that is measured from a surface side of the release layer, is 60% or more.

10. The fixing member according to claim 1,
wherein a water contact angle on a surface of the release layer is 90° or more.

11. A fixing device comprising:
a first rotating body; and
a second rotating body disposed in contact with an outer surface of the first rotating body,
wherein at least one of the first rotating body or the second rotating body is the fixing member according to claim 1.

12. A fixing device comprising:
a first rotating body; and
a second rotating body disposed in contact with an outer surface of the first rotating body,
wherein at least one of the first rotating body or the second rotating body is the fixing member according to claim 2.

13. A fixing device comprising:
a first rotating body; and
a second rotating body disposed in contact with an outer surface of the first rotating body,
wherein at least one of the first rotating body or the second rotating body is the fixing member according to claim 3.

14. A fixing device comprising:
a first rotating body; and
a second rotating body disposed in contact with an outer surface of the first rotating body,
wherein at least one of the first rotating body or the second rotating body is the fixing member according to claim 4.

15. A fixing device comprising:
a first rotating body; and
a second rotating body disposed in contact with an outer surface of the first rotating body,
wherein at least one of the first rotating body or the second rotating body is the fixing member according to claim 5.

16. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 11, that fixes the toner image on the surface of the recording medium.

17. A method of forming the release layer of the fixing member according to claim 1, the method comprising:
forming the release layer by a blade coating method.

18. A method of forming the release layer of the fixing member according to claim 1, the method comprising:
forming the release layer by a dip coating method.

19. A method of forming the release layer of the fixing member according to claim 1, the method comprising:
forming the release layer by a spray coating method.

20. A method of forming the release layer of the fixing member according to claim 1, the method comprising:
forming the release layer by a ring coating method.
